(19) United States
(12) Patent Application Publication
(10) Pub. No.: US 2018/0369677 A1
(43) Pub. Date: Dec. 27, 2018

(54) PIECE OF SPORTS EQUIPMENT FOR A GAME PLAYED WITH A SPORTS OBJECT ON A PITCH/COURT

(71) Applicant: Fraunhofer-Gesellschaft zur Förderung der angewandten Forschung e.V., München (DE)

(72) Inventor: Matthias Lochmann, Neunkirchen am Brand (DE)

(21) Appl. No.: 15/776,860

(22) PCT Filed: Nov. 14, 2016
(86) PCT No.: PCT/EP2016/077615

§ 371 Date: May 17, 2018

(30) Foreign Application Priority Data
Nov. 19, 2015 (DE) 10 2015 120 071.6

(51) Int. Cl. A63B 71/06; G08B 5/36; G08B 3/10

(52) U.S. Cl. CPC A63B 71/0619; G08B 5/36; G08B 3/10; A63B 2243/0037; G09G 3/36; A63B 2243/0025; A63B 2230/00; A63B 2225/54; A63B 2243/0095

(57) ABSTRACT

The disclosure relates to a sports apparatus for a game with a sports object on a playing field, that may include: a communication interface configured to receive at least one status signal, that relates to a game status of the game; and a display arrangement configured to change a characteristic of a display signal based at least in part on the received at least one status signal.

### CROSS-REFERENCE TO RELATED APPLICATIONS

This application is a 371 national phase filing of International Application No. PCT/EP2016/077615, entitled “PIECE OF SPORTS EQUIPMENT FOR A GAME PLAYED WITH A SPORTS OBJECT ON A PITCH/COURT”, filed 14 Nov. 2016, which claims priority to German Patent Application No. 10 2015 120 071.6, entitled “SPIELGERAT FOR EIN SPIEL MIT EINEM SPORTGEGENSTAND AUF EINEM SPIELFELD”, filed 19 Nov. 2015.

### BACKGROUND

The disclosure relates to a sports apparatus for a game with a sports object on a playing field.

Games comprising a plurality of players on a playing field, for example, ball games such as football, volleyball or basketball, often require the players to make quick adjustments to various game situations. However, a quick transfer of information from a coach to the players or between the players is often difficult to achieve.

### SUMMARY

It is the object of the present disclosure to support the execution of a game comprising a sports object on a playing field, for example, of a ball game such as football, volleyball or basketball.

The aforementioned object is achieved by the characteristics of the independent claims. Advantageous examples of the disclosure are the subject matter of the dependent claims, description and attached drawings.

According to a first aspect, the disclosure relates to a sports apparatus for a game with a sports object on a playing field, comprising: a communication interface for receiving at least one status signal, which relates to a game status of the game; and a display arrangement, which is configured to change the characteristic of a display signal depending on the received status signal. The status signal can specify the characteristic of the display signal or the change of the characteristic.

In an example, the sports apparatus is one of the following sports apparatuses: a goal or a marking device for the indication of a playing field pattern, in particular of a playing field boundary or a playing field line or a playing field area.

In an example, the display arrangement comprises at least one light element, in particular a light emitting diode (LED), wherein the display signal is, or comprises, a light signal and wherein the light element is configured to change a characteristic of the light signal depending on the status signal.

In an example, the display arrangement is configured to change at least one of the following characteristics depending on the status signal: a light frequency, a light color, a light intensity.

In an example, the display arrangement comprises an electronic display, in particular a liquid crystal display (LCD).

In an example, the display arrangement is configured to display a graphic pattern, in particular a pictogram in response to the status signal.

In an example, the display arrangement comprises an acoustic signal transducer, wherein the display signal comprises an acoustic signal and wherein the acoustic signal transducer is configured to change at least one characteristic of the acoustic signal depending on the status signal, in particular a signal frequency, a signal sequence, a signal volume, a signal shape or a signal pattern.

In an example, the status signal indicates a position of a player on the playing field or a position of the player relative to a position of another player or a position of the sports object on the playing field, in particular in a predetermined area or field of the playing field, or a position of the sports object relative to the sports apparatus or a position of the sports object relative to a position of the player or of another player, or the status signal indicates the position of the sports object and the position of the player.

The sports object can be a game object, for example, a ball. The status signal can indicate the position of the player and/or the ball.

In an example, the status signal is, or comprises, a control signal for controlling the display arrangement, wherein the control signal indicates a characteristic of the display signal, and wherein the display arrangement is configured to change at least one characteristic of the display signal according to the displayed characteristic, in particular a signal strength, a signal frequency or a signal sequence.

In an example, the status signal indicates a rule of the game or a change to a rule of the game or a playing field boundary or a change to a playing field boundary.

In an example, the status signal indicates a physiological parameter, in particular a performance-related physiological parameter of the player and/or of an opposing player.

In an example, the display arrangement is configured to change the characteristic of the display signal after expiration of a predetermined or adjustable time interval.

In an example, the display arrangement is configured to determine the change of the characteristic of the display signal.

In an example, the communication interface is configured to operate according to one of the following communication technologies: Bluetooth, WLAN, UMTS, LTE, Ethernet, Internet, RFID.

According to a second aspect, the disclosure relates to an arrangement of sports apparatuses comprising at least two sports apparatuses according to one of the preceding claims, wherein the communication interfaces of the sports apparatuses receive the same status signal or different status signals.

According to a third aspect, the disclosure relates to a control device for controlling at least one sports apparatus according to the first aspect, comprising a graphic user interface for inputting a status signal, in particular a control signal for controlling the sports apparatus and a communication interface for outputting the status signal. The control device can be configured for controlling the arrangement of sports apparatuses. The status signal can comprise the characteristics of the previously described status signals and can be generated as previously described.

### BRIEF DESCRIPTION OF THE DRAWINGS

Examples of the present disclosure will be explained with reference to the attached drawings.

FIG. 1 shows a sports apparatus

FIG. 2 shows an arrangement of sports apparatuses

### DETAILED DESCRIPTION

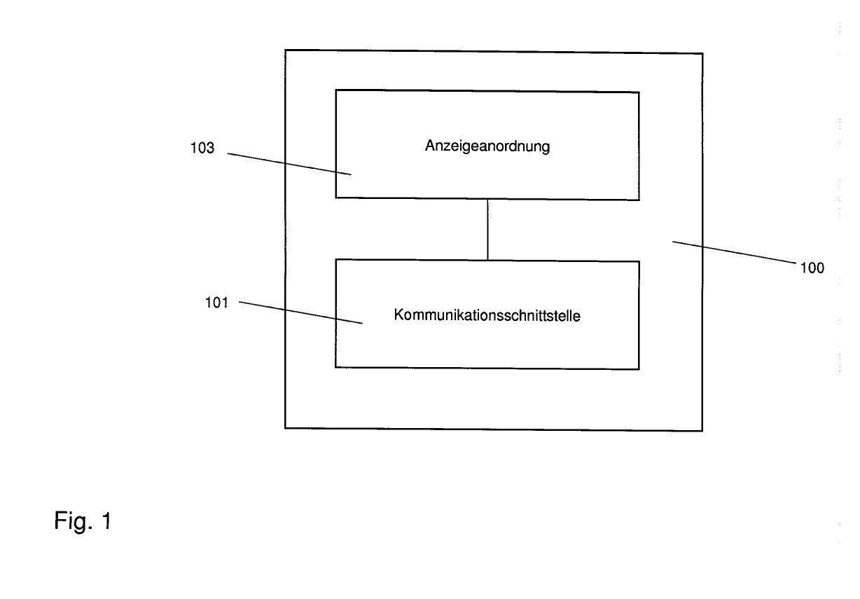

FIG. 1 schematically shows a sports apparatus 100 for a game comprising a sports object on a playing field, comprising a communication interface 101 for receiving at least one status signal, which relates to a game status of the game, and a display arrangement 103, which is configured to change the characteristic of a display signal depending on the received status signal.

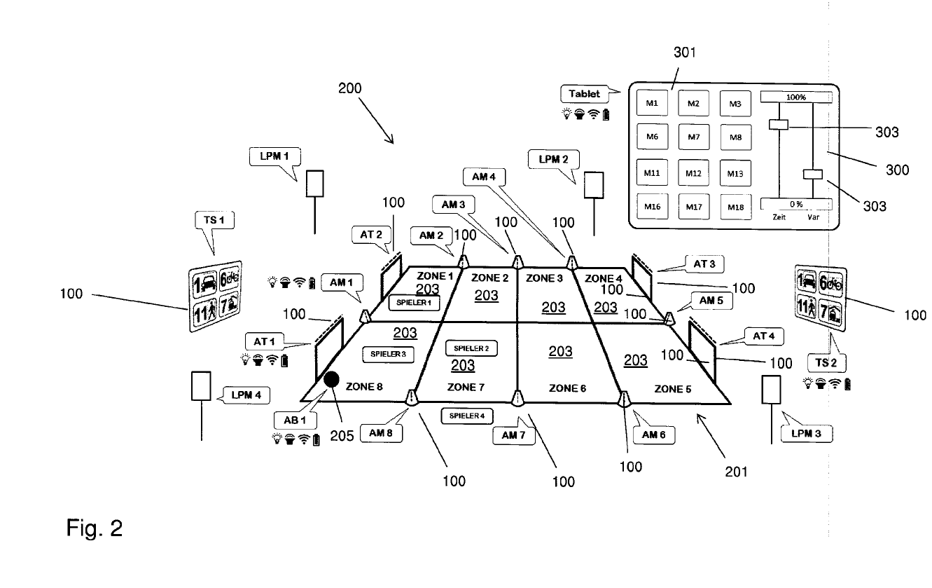

FIG. 2 shows an exemplary arrangement 200 of sports apparatuses 100 on a playing field 201 for a game comprising a sports object 205, such as a ball. The playing field 201 comprises several areas 203, which could, for example, be zones 1-8.

The arrangement 200 forms a Smart-iCourt comprising sports apparatuses 100, such as Touch Screens (TS), active goals (AT) and active marker cones (AM), into which an optical and acoustic display unit (display arrangement) 103 is installed. The sports apparatuses 100 can be controlled by means of control devices 300, such as smart phones, PCs or other control units with wireless capabilities, such as tablets.

Depending on certain statuses, the sports apparatuses 100 TS, AT or AM assume certain optical or acoustic statuses. With these statuses, expert knowledge, regulations, or constellations of if-then rules in relation to position signals, in particular position signals of players and of the ball, and bio-signals, in particular bio-signals of the players can be considered.

The optical and/or acoustic statuses of the sports apparatuses 100 can be: a constant light in a certain color, a flashing light in a certain color or in various colors, any desired noise, in particular speech or signal sounds, any desired combination of the previously described statuses, presentations on the TS, wherein the presentations can comprise pictograms with numbers, arithmetical tasks or reading tasks.

The optical and/or acoustic statuses of the sports apparatuses 100 can comprise characteristics of the display signal and/or characteristics of an acoustic signal.

The statuses, on which the sports apparatuses 100 of the Smart-iCourt depend to assume their optical and/or acoustic statuses or signal characteristics, essentially can comprise fixed specifications from an automated set of rules or specifications from a coach, who, for example, selects or specifies the same with the tablet 300.

The specifications can, for example, include that: the ATs should change colors every 30 seconds or in other time intervals (change of direction of play); diagonally positioned ATs, such as AT2 and AT 4, or AT1 and AT3, should display identical colors; the AMs on the center line, such as AM 3 and AM 7, should light up (vertical division of the field); the AMs between the goals, such as AM 1 and AM 5, should light up (horizontal division of the field); the AMs, which are positioned 6 m away from the goal, should light up (switch on shooting zones); individual ATs should emit certain audio signals, for example, to define tasks or to communicate game statuses; or that the TSs should present certain tasks.

Furthermore, the specifications can be dynamic specifications, which are regulated by if-then rules implemented either in the system—for example, on the control device 300—or in the respective sports apparatus 100.

The statuses of the Smart-iCourt or of the arrangement 200 can be made dynamic and be made depending on, for example, if-then conditions or rules formulated, for example, by coaches, sports physicians or sports scientists, which have been implemented into the system or the control device 300, depending on the positioning data of players of the same team, players of the opposing team and the ball, as well as on the physiological statuses of players of the same team and opposing team. Examples for this are:

(i) An AT 100 flashes three times in white color, as soon as (a) a player of the attacking team, for example, player 3 in FIG. 2, shoots the ball into that goal and/or (b) is located within the shooting zone, and/or as an alert that a goal will be counted. The position data of the player can be monitored with a positioning system (RedFIR, Catapult, video, etc.), for example in real time. Furthermore, a ball positioning system (RedFIR, GoalREF, etc.) can monitor whether the ball has crossed the goal line.
(ii) An AT 100 flashes three times in white color, as soon as (a) a player of the attacking team, for example, player 3 in FIG. 2, moves the ball into this AT and/or (b) is positioned within the shooting zone and/or (c) all players of the attacking team are positioned in the opponent's half of the field, for example, player 1 and 2, and/or (d) if the AM 100 at the center line emit a white light signal. This can facilitate a compact team movement. The position data of the players can be monitored with the positioning system (RedFIR, Catapult, video, etc.), for example in real time. Furthermore, the ball positioning system (RedFIR, GoalREF, etc.) can monitor whether the ball has crossed the goal line.
(iii) An AT 100 flashes three times in white color, as soon as (a) a player of the attacking team, for example, player 3 in FIG. 2, moves the ball into this AT and/or (b) is positioned within the shooting zone and/or (c) both of the two playing field halves are occupied by at least one attacking player at any time of the attack, for example, player 2 and 3 on the left and player 3 on the right in FIG. 2, and/or (d) if the marker cones between the goals emit a white light signal. This can facilitate the use of the width of the playing field 201. The position data of the players can be monitored with the positioning system (RedFIR, Catapult, video, etc.), for example in real time. Furthermore, the ball positioning system (RedFIR, GoalREF, etc.) can monitor whether the ball has crossed the goal line.

The above examples serve to illustrate the function of the arrangement 200 and/or the sports apparatuses 100. In particular, the ATs 100 can flash more or fewer times than three times, or can flash in color.

The example of a Smart-iCourt shown in FIG. 2 comprises the positioning system (LPM).

The control device 300 can comprise a user interface 301 and adjustment elements 303, for example, sliders. The user interface 301 can comprise a plurality of operating elements M1 to M18, which can be used to select the sports apparatuses 100 individually or in groups of sports apparatuses 100 of the same type. The adjustment elements 303 can be used to change the characteristic of the respective status signal or the characteristic of the display signal. The status signal further can specify the characteristic of the display signal.

The control device 300 further can comprise a communication interface for outputting a control signal to one or more sports apparatuses 100, for example, according to one of the aforementioned communication technologies.

The control device 300 can comprise a processor and/or a memory. The memory can be loaded with specific statuses and/or status signals, which can be recalled. The processor can be configured to implement the status signals according to specified rules. The communication interface can receive position signals from the players or the ball for this purpose and generate a status signal depending on the positions, as described in the examples above.

The status signals also can be adjusted based on performance-related physiological parameters of the players, such as pulse, oxygen saturation or blood-sugar levels. The respective communication interface therefore can be configured to receive the performance-related physiological parameters of the players and to take them into account when implementing the status signal, for example, by changing the characteristic of a display signal.

The respective status signal can be associated with the respective status and/or indicate the respective status.

### LIST OF REFERENCE NUMBERS

100 Sports apparatus
101 Communication interface
103 Display arrangement
200 Arrangement of sports apparatuses
201 Playing field
203 Playing field area
205 Sports object
300 Control device
301 User interface
303 Adjustment element

What is claimed is:

1. A sports apparatus for a game comprising a sports object on a playing field, comprising:
a communication interface configured to receive at least one status signal that relates to a game status of the game; and
a display arrangement configured to change a characteristic of a display signal based at least in part on the at least one status signal.

2. The sports apparatus according to claim 1, wherein the sports apparatus comprises one or more of: a goal or a marking device configured to indicate a playing field pattern.

3. The sports apparatus according to claim 1, wherein the display arrangement comprises at least one light element, wherein the display signal comprises a light signal, and wherein the light element is configured to change a characteristic of the light signal based at least in part on the at least one status signal.

4. The sports apparatus according to claim 3, wherein the display arrangement is configured to change one or more of the following characteristics based at least in part on the at least one status signal: a light frequency, a light color, or a light intensity.

5. The sports apparatus according to claim 1, wherein the display arrangement comprises a liquid crystal display (LCD).

6. The sports apparatus according to claim 1, wherein the display arrangement is configured to display a graphic pattern in response to the at least one status signal.

7. The sports apparatus according to claim 1, wherein the display arrangement comprises an acoustic signal transducer, wherein the display signal comprises an acoustic signal, and wherein the acoustic signal transducer is configured to change at least one characteristic of the acoustic signal based at least in part on the at least one status signal, wherein the at least one characteristic of the acoustic signal comprises one or more of: a signal frequency, a signal sequence, a signal volume, a signal shape or a signal pattern.

8. The sports apparatus according to claim 1, wherein the at least one status signal indicates one or more of: a position of a player on the playing field, or a position of the player relative to a position of another player or a position of the sports object on the playing field in a predetermined area or zone of the playing field, or a position of the sports object relative to the sports apparatus, or a position of the sports object relative to a position of the player or of another player, or the position of the sports object and the position of the player.

9. The sports apparatus according to claim 1, wherein the at least one status signal is comprises a control signal configured to control the display arrangement, wherein the control signal indicates a characteristic of the display signal, and wherein the display arrangement is configured to change one or more of the following characteristic of the display signal: a signal strength, a signal frequency, or a signal sequence according to the displayed characteristic.

10. The sports apparatus according to claim 1, wherein the at least one status signal indicates one or more of: a rule of the game, or a change to a rule of the game, or a playing field boundary, or a change to a playing field boundary.

11. The sports apparatus according to claim 1, wherein the at least one status signal indicates a physiological parameter comprising a performance-related physiological parameter of a player or of an opposing player.

12. The sports apparatus according to claim 1, wherein the display arrangement is configured to change the characteristic of the display signal after expiration of a predetermined or adjustable time interval.

13. The sports apparatus according to claim 1, wherein the display arrangement is configured to determine the change of the characteristic of the display signal.

14. The sports apparatus according to claim 1, wherein the communication interface is configured to operate according to one of the following communication technologies: Bluetooth, WLAN, UMTS, LTE, Ethernet, Internet, or RFID.

15. The sports apparatus according to claim 1, wherein the communication interfaces of at least two sports apparatuses receive the same status signal or different status signals.

16. The sports apparatus according to claim 1, further comprising:
a control device configured to control at least one of the sports apparatus, comprising:
a graphic user interface configured to input the status signal configured to control the sports apparatus; and
a communication interface configured to output the status signal.

17. The sports apparatus according to claim 2, wherein the marking device for the indication of a playing field pattern comprises one or more of: a playing field boundary, a playing field line, or a playing field area.

18. The sports apparatus according to claim 3, wherein the at least one light element comprises a light emitting diode (LED).

19. The sports apparatus according to claim 6, wherein the graphic pattern comprises a pictogram.

20. The sports apparatus according to claim 7, wherein at least one characteristic of the acoustic signal comprise one or more of: a signal frequency, a signal sequence, a signal volume, a signal shape, or a signal pattern.
